(19) United States
(12) Patent Application Publication
(10) Pub. No.: US 2022/0376525 A1
(43) Pub. Date: Nov. 24, 2022

(54) TEMPERATURE MONITORED CHARGING CONNECTOR PART

(71) Applicant: PHOENIX CONTACT E-Mobility GmbH, Schieder-Schwalenberg (DE)

(72) Inventor: Thomas Fuehrer, Blomberg (DE)

(21) Appl. No.: 17/623,296

(22) PCT Filed: Jun. 22, 2020
(86) PCT No.: PCT/EP2020/067274

§ 371 Date: Dec. 28, 2021

(30) Foreign Application Priority Data
Jul. 1, 2019 (DE) 10 2019 117 648.4

(51) Int. Cl. H02J 7/00; H01R 13/66; B60L 53/62; B60L 53/16

(52) U.S. Cl. CPC H02J 7/0042; H02J 7/0047; H02J 7/00714; H02J 7/007192; H01R 13/6683; B60L 53/62; B60L 53/16; H02J 7/00309

(57) ABSTRACT

A connector part for connecting to a mating connector part includes at least one load contact and at least one temperature sensor for detecting a temperature of the at least one load contact. The connector part further includes an evaluation unit. The evaluation unit is configured to detect at least one sensor value of the at least one temperature sensor and at least one value of a parameter with respect to an electric current flow via the at least one load contact.

### CROSS-REFERENCE TO PRIOR APPLICATIONS

This application is a U.S. National Phase application under 35 U.S.C. § 371 of International Application No. PCT/EP2020/067274, filed on Jun. 22, 2020, and claims benefit to German Patent Application No. DE 10 2019 117 648.4, filed on Jul. 1, 2019. The International Application was published in German on Jan. 7, 2021 as WO 2021/001183 under PCT Article 21(2).

### FIELD

The invention relates to a connector part for connecting to a mating connector part, a charging station for charging an electric vehicle, an electronics assembly, and a connector system.

### BACKGROUND

Particularly in the field of E-mobility, there are particularly high requirements for connector parts and associated charging cables with regard to their functional performance, stability, and safety. In order to charge traction batteries of electric vehicles in as short a time as possible, in part, direct currents of up to 500 amps (A) are transmitted.

If a connector part is used for several years with in some cases several thousand charging cycles, and especially due to environmental influences, wear or damage to the connector part or a matching mating connector part can occur. Increased contact resistances can thereby occur, for example, between load contacts of the connector part and of the mating connector part. In the case of high charging currents, such contact resistances can lead to an intense heating, which in turn can cause damage or even failure of the connector part.

In order to avoid such consequences of contact resistances, connector parts can be equipped with temperature monitoring in order to abort the charging process in the event of unacceptable heating before damage occurs.

DE 10 2014 111 185 A1 describes a connector part for connecting to a mating connector part and to a temperature sensor device for detecting heating at the connector part, wherein the temperature sensor unit has at least one sensor element which is designed to detect infrared radiation emitted by the at least one electrical contact element. This makes it possible to take countermeasures particularly quickly—for example, switching off a charging current.

### SUMMARY

In an embodiment, the present invention provides a connector part for connecting to a mating connector part, the connector part comprising at least one load contact, at least one temperature sensor for detecting a temperature of the at least one load contact, and an evaluation unit configured to detect at least one sensor value of the at least one temperature sensor and at least one value of a parameter with respect to an electric current flow via the at least one load contact.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a view of a charging station having a cable arranged thereon and a connector part, and of a vehicle having a mating connector part;

FIGS. 2 and 3 show views of the connector part according to FIG. 1; and

FIGS. 4 through 7 show parts of the connector part according to FIGS. 2 and 3 in different views.

### DETAILED DESCRIPTION

In some embodiments, the present invention enables monitoring of the state of a connector part as precisely as possible.

Accordingly, a connector part for electrically connecting to a mating connector part is provided, which comprises a load contact (or several load contacts), a temperature sensor for detecting a temperature of the load contact (or several temperature sensors), and an evaluation unit. The evaluation unit is designed to detect at least one sensor value of the temperature sensor and at least one value of a parameter with respect to an electric current flow via the load contact (or current flow parameter).

This is based upon the knowledge that particularly precise statements regarding the state of the connector part are possible if the current flow is also considered in addition to the temperature of a load contact.

The connector part further comprises, for example, a current-measuring device for measuring an amperage of an electric current (e.g., a charging current), flowing through the load contact, as a current flow parameter. Certain temperatures may be harmless at certain amperages, but at other amperages indicate too high a contact resistance. For example, a high but still acceptable temperature at a high amperage can be in the normal range, but, at a comparatively low amperage, may exhibit a problem. It is thus possible to already detect problems early before, for example, a critical temperature threshold value is reached. Alternatively or additionally, the evaluation unit of the connector receives the charging current, which is generally regulated by a charging station, e.g., a charging column, and/or another current flow parameter from the charging station, e.g., by electronics in the charging station. For this purpose, the evaluation unit optionally comprises a communications interface.

The evaluation unit may further be designed to determine a duration of a current flow as a current flow parameter. For this purpose, it measures, for example, the duration of an amperage differing from zero. If a certain temperature value is already reached after a comparatively short duration, it is possible, for example, to infer too high a contact resistance, even before significantly higher temperatures are reached.

Optionally, the evaluation unit is designed to determine a performance parameter, (at least) on the basis of the at least one sensor value of the temperature sensor and the at least one value of the current flow parameter. The performance parameter is, for example, indicative of a performance of the connector part. The performance parameter allows a particularly simple statement regarding the state of the connector part.

According to a further development, the evaluation unit comprises a memory and/or a processor. At least one comparison value is stored in the memory. The processor serves, for example, to compare the performance parameter to the comparison value. The comparison value can, for example, specify the performance parameter for the new state of the connector part.

Optionally, the evaluation unit is designed, on the basis of the at least one sensor value of the temperature sensor and the at least one current flow parameter (and/or on the basis of the performance parameter determined therefrom), to output a control signal for lowering an amperage of an electric current transmitted by the load contacts and/or for interrupting the electric current transmitted by the load contacts.

The connector part can comprise at least two load contacts. Optionally, the connector part comprises for each load contact at least one temperature sensor for detecting a temperature of the corresponding load contact. This makes it possible to quickly detect if intense heating is occurring in any of the load contacts.

Furthermore, the connector part can comprise a temperature sensor, which is arranged and designed to detect an ambient temperature.

Optionally, the evaluation unit is designed to calculate a relative load contact temperature on the basis of the temperature of the load contact and the ambient temperature, e.g., by forming a difference of the (absolute) temperature of the load contact minus the ambient temperature. This makes it possible to compensate for distortion of the load contact temperature by, for example, particularly high or low ambient temperatures.

The connector part optionally comprises a handle. The connector part can be operated manually on the handle—in particular, can be plugged into the mating connector part and can be removed therefrom. The temperature sensor for detecting the ambient temperature is, optionally, arranged on the handle.

The connector part may be a high-amperage and/or high-voltage connector part. For example, the connector part is designed to conduct electric currents having a power of 10 kilowatts (kW) or more—in particular, of 50 kW or more, 135 kW or more, or 350 kW or more. Alternatively or additionally, the connector part is designed to conduct electric currents having amperages of 100 A or more—in particular, of 200 A or more, in particular, of 300 A or more, in particular, of 500 A or more.

According to one aspect, a charging station for charging an electric vehicle is provided. The charging station comprises at least one connector part according to any embodiment described herein. The charging station is connected, for example, to a power grid.

According to one aspect, an electronics assembly for the connector part is provided according to any embodiment described herein, comprising the at least one temperature sensor, the evaluation unit, and the current-measuring device for measuring the amperage of an electric current flowing through the load contact of the connector part.

According to one aspect, a connector system is provided, having a connector part with one or two load contacts, one or more temperature sensors, a current-measuring device for detecting an amperage of an electric current flowing through the load contact, and an evaluation unit. The evaluation unit is designed to detect at least one sensor value of the temperature sensor, at least one value for the amperage from the current-measuring device, and the duration of an electric current flow through the load contacts, to perform, based upon the detected values, a comparison to at least one comparison value, and, based upon a result of the comparison, to generate a control signal. The sensor value of the temperature can be determined relative to the ambient temperature.

The idea forming the basis of the invention is explained in more detail below on the basis of exemplary embodiments shown in the figures.

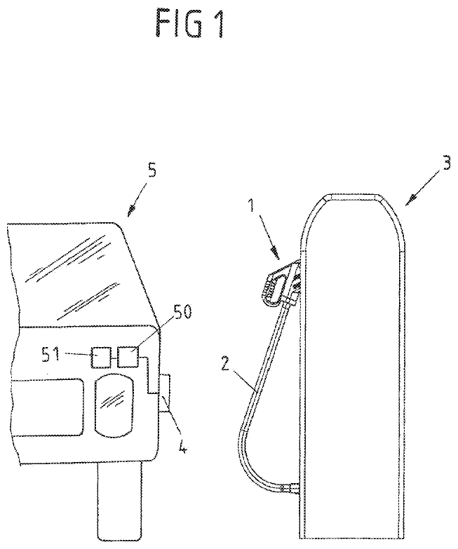

FIG. 1 shows an electrically-driven vehicle 5 in the form of an electric vehicle, having a multiply-chargeable battery 51 and a charging device 50. The vehicle 5 has one or more electric motors that can be driven by current from the battery 51. A connector for connecting the vehicle 5 to a charging station 3 is provided for charging and/or discharging the battery 51.

The connector comprises two, mutually-matching and detachable, electrically-connectable connector parts 1, 4, each of which serves as a mating connector part of the respective other connector part. One of the connector parts 1, 4 is fixedly connected to a cable 2, which connects the connector part 1 to the charging station 3 (here, fixedly; alternatively, via an additional connector). The other of the two connector parts 1, 4 is fixedly mounted on the vehicle 5 and is hereafter referred to as the mating connector part 4.

The charging station 3 is designed to provide a charging current for charging the vehicle 5. In the present case, the charging station 3 is designed to provide a charging current in the form of a direct current (alternatively or additionally, an alternating current). In the example shown, the charging station 3 is a high-power charging station that can provide charging currents with an amperage of more than 100 A—in the present case, 500 A.

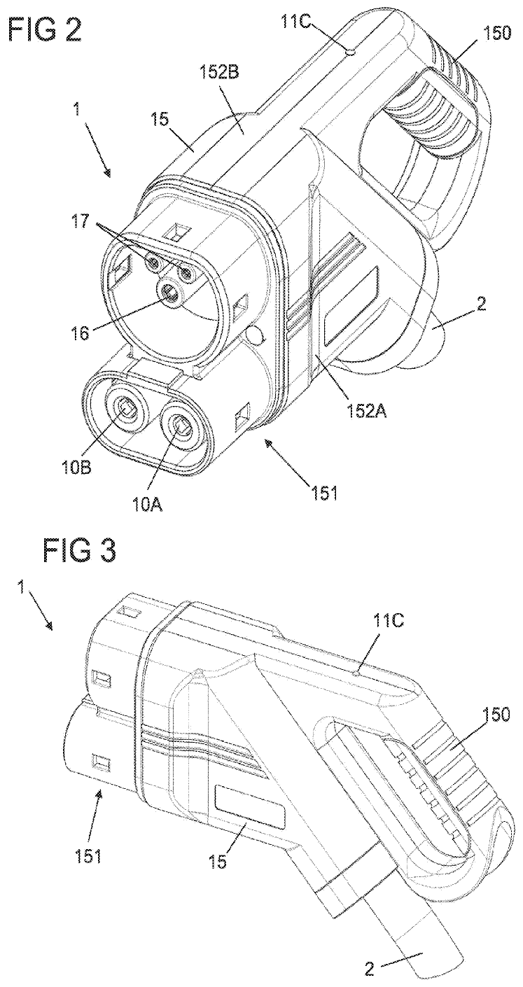

FIGS. 2 and 3 show the connector part 1 of the charging station 3 in different views. In the present case, the connector part 1 is designed according to the CCS (combined charging system) Type 2 standard.

The connector part 1 comprises two load contacts 10A, 10B for transmitting a direct current. The load contacts 10A, 10B are each designed for electrically contacting a corresponding mating contact of the mating connector part 4 (in the present case, for receiving a contact pin). Furthermore, the connector part 1 comprises a protective conductor contact 16 (PE contact) and further contacts 17—for example, for data transmission.

The connector part 1 comprises a housing 15 with housing shells 152A, 152B and a plug-in section 151. The plug-in section 151 carries the load contacts 10A, 10B, the protective conductor contact 16, and the further contacts 17. The plug-in section 151 is held between the housing shells 152A, 152B.

The housing 15—specifically, the housing shells 152A, 152B—form a handle 150 on which the connector part 1 can be gripped by a user and plugged into or detached from the mating connector part 4.

The cable 2 is connected to the connector part 1. The cable 2 comprises a corresponding conductor for each of the load contacts 10A, 10B, the protective conductor contact 16, and the further contacts 17.

Electric currents of several hundred amperes can be transmitted to the mating connector part 4 via the load contacts 10A, 10B. If too large a contact resistance exists between at least one of the load contacts 10A, 10B and a corresponding mating contact of the mating connector part 4 during power transmission, the load contact 10A, 10B can, consequently, heat up. Such a contact resistance is, for example, the result of a worn contact contour of one or both load contacts 10A, 10B, contamination, or corrosion.

If the load contact 10A, 10B heats up, or if both load contacts 10A, 10B heat up too intensely, this may damage the connector part 1 and/or the mating connector part 4, or even pose a risk to the user.

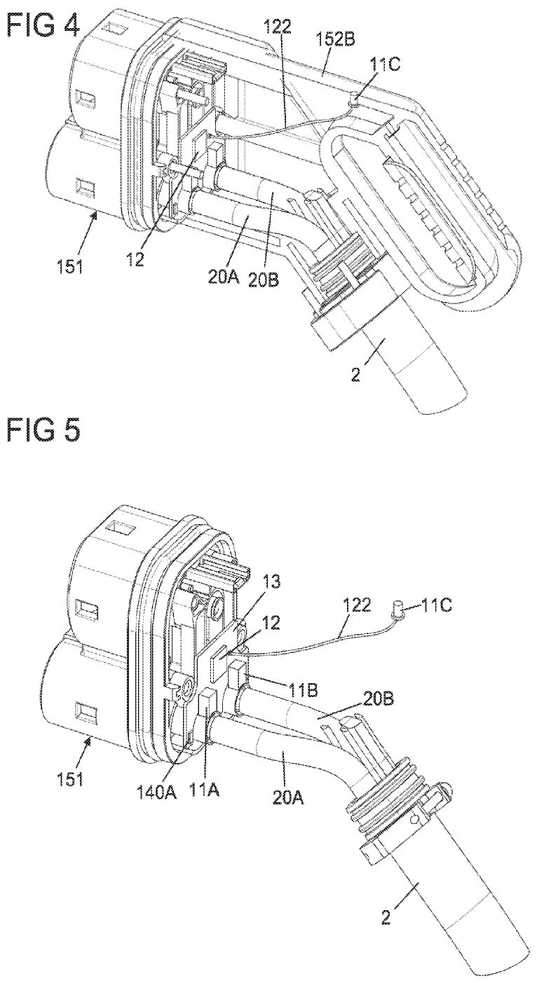

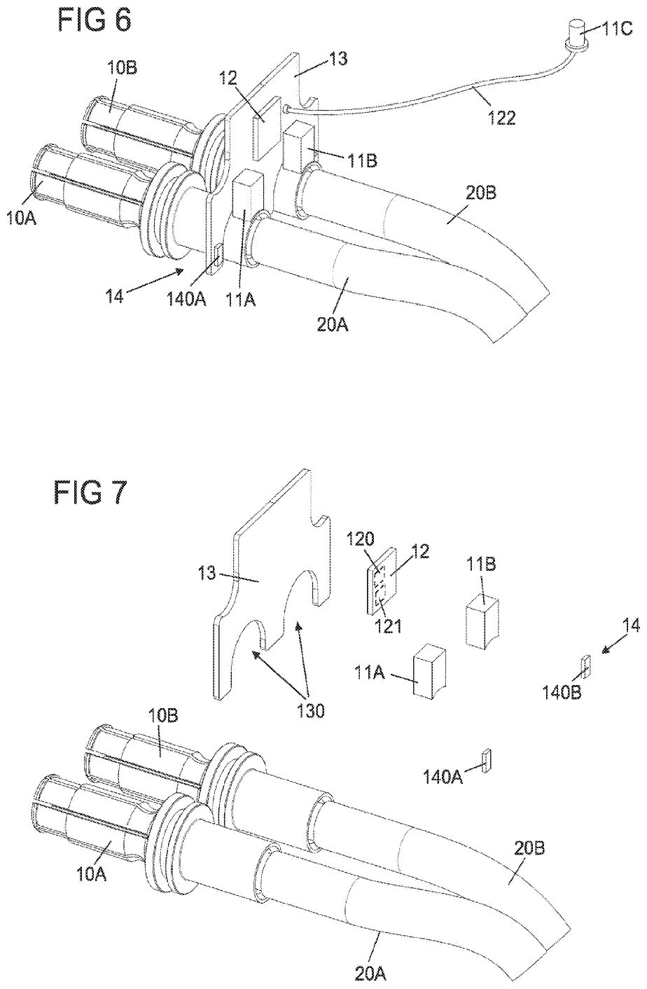

In particular with reference to FIGS. 4 through 7, which show further components of the connector part 1, it can be seen that the connector part 1 comprises at least one temperature sensor 11A, 11B for detecting a temperature of at least one load contact 10A, 10B and an evaluation unit 12. The evaluation unit 12 is designed to detect at least one sensor value of the at least one temperature sensor 11A, 11B and at least one value of a current flow parameter with respect to an electric current flow via the load contact 10A, 10B. This enables particularly precise statements regarding the current state of the connector part 1. In the present case, the evaluation unit 12 is an electronic evaluation unit.

In the example shown, the connector part 1 comprises in each case a temperature sensor 11A, 11B for detecting the temperature of each of the two load contacts 10A, 10B. For this purpose, each of the temperature sensors 11A, 11B is arranged adjacent to (in the present case, in contact with) one of the two load contacts 10A, 10B. Each of the temperature sensors is designed, for example, as a temperature-dependent resistor or as an infrared sensor. The evaluation unit 12 is designed to obtain sensor values from both temperature sensors 11A, 11B of the load contacts 10A, 10B.

In addition to the temperature sensors 11A, 11B for measuring the temperatures of the load contacts 10A, 10B, the connector part 1 comprises a temperature sensor 11C for measuring an ambient temperature. The temperature sensor 11C for measuring the ambient temperature is mounted on an outer wall of the housing 15—in the present case, in a recess between the housing shells 152A, 152B. In order to be influenced as little as possible by the heating of the load contacts 10A, 10B, the temperature sensor 11C for the ambient temperature is arranged at a distance (as far as possible) from the load contacts 10A, 10B—here, by way of example, in the region of the handle 150 and, in the present case, on the upper side of the housing. The temperature sensor 11C for the ambient temperature is furthermore arranged such that it has a good thermal connection to the environment.

The evaluation unit 12 is designed to determine relative temperatures of the load contacts 11A, 11B from the sensor values of the temperature sensors 11A, 11B of the load contacts 10A, 10B and from sensor values of the temperature sensor 11C—for example, by difference formation. An influence of the ambient temperature on the measured temperatures of the load contacts 10A, 10B can thus be corrected.

The connector part 1 comprises a circuit board 13. The temperature sensor 11C for the ambient temperature is connected via a connecting line 122 to the printed circuit board 13 and, above it, to the evaluation unit 12. In the present case, the evaluation unit 12 is configured in the form of an electronics module which is connected to the printed circuit board 13. The circuit board 13 has a recess 130 for each load contact 10A, 10B. The load contacts 10A, 10B are (at least) partially accommodated In the recesses 130.

The load contacts 10A, 10B specify a plug-in direction along which the connector part 1 can be plugged into or onto the mating connector part 4. The circuit board 13 is flat and oriented to be perpendicular to the plug-in direction.

As shown in FIGS. 4 through 7, the load contacts 10A, 10B are each connected to a line 20A, 20B (specifically, a DC line in each case) of the cable 2.

The shown evaluation unit 12 detects several current flow parameters. In the present example, the evaluation unit 12 detects amperages of electric current flowing through the two load contacts 10A, 10B (alternatively, only one), as well as the duration of the current flow.

For measuring the amperage through each of the load contacts 10A, 10B, the connector part 1 comprises a current-measuring device 14. The current-measuring device 14 is arranged in the housing 15. In the present case, the current-measuring device 14 has two magnetic-field sensors 140A, 140B. Each of the magnetic-field sensors 140A, 140B is arranged adjacent to one of the load contacts 10A, 10B in order to detect (indirectly and contactlessly) the magnetic field of the charging current paths, from which the respective amperage can be inferred. In order to be influenced as little as possible by the respective other load contact 10A, 10B, the magnetic field sensors 140A, 140B of the load contacts 10A, 10B are each arranged on the side of the corresponding load contact 10A, 10B which faces away from the other load contact 10A, 10B. This is made possible in a particularly simple manner by receiving the load contacts 10A, 10B in the recesses 130 of the circuit board 13.

The evaluation unit 12 detects the duration of the current flow, e.g., by determining how long an amperage exceeding a predetermined threshold value, e.g., an amperage differing from zero (without interruption, or with interruptions below a predetermined duration), is detected by means of the current-measuring device 14.

The evaluation unit 12 allows particularly precise statements about the state of the connector part 1 by detecting the relative temperatures of the load contacts 10A, 10B and at least one current flow parameter. For example, the evaluation unit 12 can detect that a comparatively high relative temperature of one or both load contacts 10A, 10B occurs at a comparatively low charging current, even after a short time. The evaluation unit 12 can then, for example, detect that too large a contact resistance is present, even before the temperature continues to rise. Further deterioration of the state of the connector part 1, and in some cases also of the mating connector part 4, can thus be prevented in good time.

The evaluation unit 12 is designed to output control signals, e.g., to the charging station 3, e.g., for lowering or switching off the charging current in the event that a state of the connector part 1 that is not sufficient for a specific charging current is present. Alternatively or additionally, if an excessively high temperature is detected, the evaluation unit 12 can terminate normative communication with the charging station 3 in order to thus cause the charging station 3 to switch off as quickly as possible.

The evaluation unit 12 includes a processor 120 and a memory 121. For example, the evaluation unit 12 is a microcontroller with data memory. The memory 121 stores, for example, comparison values and/or threshold values, which the processor 120 can read in order to compare them to one or more measured values.

Furthermore, the evaluation unit 12 is designed to calculate a performance parameter from the measured variables of time (duration of the current flow), amperage, and temperature (relative temperature of the load contacts 10A, 10B). The performance parameter is, for example, indicative of a performance and/or a state of the connector part 1. In the present case, the performance parameter describes the heating behavior during a charging process. The performance parameter can, for example, be the relative increase in temperature per unit time of the charging process. Optionally, the performance parameter additionally takes into account a time interval from a previous charging process. The evaluation unit 12 may be designed to determine the duration between the beginning of the current charging process and the end of the preceding charging process (and to include it in the determination of the performance parameter). A heating up due to the previous charging process which has not yet completely subsided can thus be taken into account. For example, after a cold night, the first charging process shows a different temperature profile, such as the fifth one.

The evaluation unit 12 compares the determined performance parameter to specified values in the memory 121. In the event of a deterioration of the parameter, the evaluation unit 12 calculates a correction measure (for example, lowering the amperage by an amount corresponding to the performance parameter, or switching off) and communicates it to the charging station 3. The default values stored in the memory 121 correspond, for example, to the performance parameter of the connector part 1 in the new state or ideal state.

In addition to a single performance parameter, a parameter curve can also be determined by the evaluation unit 12 and can be comparable to a comparison curve stored in the memory 121.

Optionally, the performance parameter is forwarded (by the evaluation unit 12 or the charging station 3), for example, telemetrically, so that central monitoring of many charging devices in this respect becomes possible.

Because electronics are already provided in many cases in charging connector parts, adding the temperature sensors 11A-11C, the current-measuring device 14, and the evaluation unit 12 is especially easy to implement. Alternatively, all other measured variables (except for the temperatures of the load contacts 10A, 10B) are detected by the charging station 3 (as a connector system).

With the evaluation unit 12, it is thus possible to actively and particularly precisely monitor the performance of the connector part 1.

In the present case, the temperature sensors 11A-11C, the evaluation unit 12, the circuit board 13, and the current-measuring device 14 form an electronic assembly.

The connector part 1 is thus a charging connector part that automatically monitors its performance (in terms of current-carrying capability). For this purpose, charging current and duration are measured, as well as the temperature increase of the load contacts 10A, 10B relative to the surroundings. The ratio of two of the variables (e.g., charging current and relative temperature increase) is converted internally into the performance parameter. This is compared to the type-specific values in the new state. In the event of deviations above a predetermined threshold value, the electronics in the charging plug calculate which measure (for example, current reduction or shutdown) is to be carried out by the charging device, and trigger it. The evaluation unit 12 determines, for example, the following measurement variables: the charging current, the charging time period, the temperature of the load contacts—separately for each of the current paths—and the ambient temperature.

The above description in connection with the connector part 1 is merely exemplary, and the connector part 1 could in particular also take the form of the corresponding mating connector part 4, i.e., instead of a handle, be mounted or be mountable on the vehicle 5.

According to an alternative, a sensor system is provided in which the evaluation unit 12 and the current-measuring device 14 are arranged on the charging station 3, and the evaluation unit 12 receives the sensor values of the temperature sensors 11A-11C wirelessly or via the cable 2, for example.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS

1 Connector part
10A, 10B Load contact
11A-11C Temperature sensor
12 Evaluation unit
120 Processor
121 Memory
122 Connecting lead
13 Printed circuit board
130 Recess
14 Current-measuring device
140A, 140B Magnetic field sensor
15 Housing
150 Handle
151 Plug-in section
152A, 152B Housing shell
16 Protective conductor contact
17 Contact
2 Cable
20A, 20B Line
3 Charging station
4 Mating connector part
5 Vehicle
50 Charging device
51 Battery

1. A connector part for connecting to a mating connector part, the connector part comprising:
at least one load contact;
at least one temperature sensor for detecting a temperature of the at least one load contact; and
an evaluation unit configured to detect at least one sensor value of the at least one temperature sensor and at least one value of a parameter with respect to an electric current flow via the at least one load contact.

2. The connector part according to claim 1, further comprising a current-measuring device for measuring an amperage of an electric current flowing through the load contact as the parameter with respect to the electric current flow via the at least one load contact.

3. The connector part according to claim 1, wherein the evaluation unit is configured to determine a duration of a current flow as the parameter with respect to the electric current flow via the at least one load contact.

4. The connector part according to claim 1, wherein the evaluation unit is configure to determine a performance parameter on the basis of the at least one sensor value of the temperature sensor and the at least one value of the parameter with respect to the electric current flow via the at least one load contact.

5. The connector part according to claim 4, wherein the evaluation unit comprises a memory in which at least one comparison value is stored and a processor for comparing the performance parameter to the comparison value.

6. The connector part according to claim 1, wherein the evaluation unit is configured, based upon the at least one sensor value of the temperature sensor and the at least one parameter with respect to the electric current flow via the at least one load contact, to output a control signal for lowering an amperage of an electric current transmitted by the at least one load contacts.

7. The connector part according to claim 1, wherein the at least one load contact comprises two load contacts and, for each of the two load contacts, a temperature sensor, of the at least one temperature sensor, is configured to detect a temperature of the respective load contact.

8. The connector part according to claim 1, further comprising a second temperature sensor for detecting an ambient temperature.

9. The connector part according to claim 8, wherein the evaluation unit is configured to calculate a relative load contact temperature based on the temperature of the at least one load contact and the ambient temperature.

10. The connector part according to claim 8, further comprising a handle, wherein the second temperature sensor is arranged on the handle for detecting the ambient temperature.

11. The connector part according to claim 1, wherein the connector part is configured to conduct electric currents of 200 amps (A) or more.

12. A charging station for charging an electric vehicle, comprising the connector part according to claim 1.

13. An electronics assembly for the connector part according to claim 1, comprising the at least one temperature sensor, the evaluation unit, and a current-measuring device for measuring an amperage of an electric current flowing through the at least one load contact of the connector part.

14. A connector system, comprising:
a connector part with at least one load contact,
at least one temperature sensor,
a current-measuring device for detecting an amperage of an electric current flowing through the at least one load contact, and
an evaluation unit, which is configured to:
detect at least one sensor value of the at least one temperature sensor, at least one value for the amperage from the current-measuring device, and a duration of the electric current flow through the at least one load contact;
perform, based on the at least one sensor value of the at least one temperature sensor, the at least one value for the amperage from the current-measuring device, and the duration of the electric flow through the at least one load contact, a comparison to at least one comparison value; and
based upon a result of the comparison, generate a control signal.
